(19) United States
(12) Patent Application Publication
(10) Pub. No.: US 2026/0056028 A1
(43) Pub. Date: Feb. 26, 2026

(54) SYSTEM AND METHOD FOR VISUALIZATION OF GEOSPATIAL POSITIONING AND MANAGEMENT OF ELECTRICAL INFRASTRUCTURE ASSETS

(71) Applicant: Joseph Brian Wiggins, La Pine, OR (US)

(72) Inventor: Joseph Brian Wiggins, La Pine, OR (US)

(21) Appl. No.: 18/810,286

(22) Filed: Aug. 20, 2024

(51) Int. Cl. G01C 21/00

(52) U.S. Cl. CPC G01C 21/3811; G01C 21/3867

(57) ABSTRACT

A method for visualization of geospatial positioning and management of electrical infrastructure assets involves assigning a data set with visual data, spatiotemporal data, geo-positional data, and point cloud data to a data pool. The method maps the data set to a geographic information system as at least one virtual asset. The method visualizes the at least one virtual asset with a placemark on virtual geographic map. The method applies severity annotations to the at least one virtual asset. The method groups the at least one virtual asset with at least one other virtual asset based on proximity of the placemark on the virtual geographic map. The method generates an assets report comprising the severity annotations for the at least one infrastructure asset. The method generates an encroachment report comprising encroachment severity from the point cloud data of the at least one infrastructure assets.

### BACKGROUND

Electrical infrastructure management and upkeep face a myriad of challenges that stem from aging infrastructure, increasing demand, and evolving technological landscapes. One significant issue is the aging power grid, where much of the equipment and transmission lines are decades old and prone to failures, leading to frequent outages and reliability concerns.

Upgrading this infrastructure requires substantial investment and time, often constrained by budget limitations and regulatory hurdles. Additionally, the increasing demand for electricity, driven by population growth and the proliferation of electric vehicles and smart devices, puts further strain on the existing grid. Integrating renewable energy sources like solar and wind power adds complexity, as these sources are intermittent and require advanced grid management solutions to ensure stability and reliability.

Assessing the state of electrical poles and lines presents several difficulties, primarily due to the vast and dispersed nature of these structures. The sheer number of poles and miles of lines across urban, suburban, and rural areas makes comprehensive inspection a labor-intensive and time-consuming task. Many poles and lines are located in hard-to-reach areas, such as dense forests, mountains, or remote regions, complicating access for inspectors. Weather conditions and natural wear and tear, such as corrosion, wood rot, and damage from storms or animals, vary significantly by location, necessitating frequent and detailed inspections. Technological limitations also pose a challenge; while drones and remote sensing technologies can aid in assessments, they are not yet universally implemented and can be costly. Additionally, the data collected from inspections must be meticulously analyzed and integrated into existing maintenance schedules, requiring advanced data management systems and skilled personnel.

Planning upkeep for electrical infrastructure involves navigating a complex array of challenges that require careful coordination, foresight, and resource management. One primary difficulty is the need to balance immediate maintenance needs with long-term modernization efforts, all within the constraints of limited budgets and funding. Aging infrastructure demands regular inspections and repairs, which can be unpredictable and costly, diverting resources from planned upgrades and improvements. The widespread and diverse nature of electrical networks, spanning urban centers to remote rural areas, adds logistical complexity to scheduling and executing maintenance activities. Additionally, ensuring minimal disruption to power supply during maintenance work is a critical concern, necessitating intricate planning and coordination with various stakeholders, including utility companies, regulatory bodies, and customers. Rapid technological advancements and evolving energy demands further complicate planning, as utilities must anticipate future needs and integrate new technologies such as smart grids and renewable energy sources. Workforce challenges, including a shortage of skilled technicians and engineers, exacerbate these difficulties, as there is a need for specialized training and expertise to handle both existing infrastructure and new technologies.

Therefore a need exists for a tool that allows for the assessment and management of electrical infrastructure asset.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system 100 for visualization of geospatial positioning and management of electrical infrastructure assets in accordance with one embodiment.

FIG. 2 illustrates a system 200 for visualization of geospatial positioning and management of electrical infrastructure assets in accordance with one embodiment.

FIG. 3 illustrates a method 300 for visualization of geospatial positioning and management of electrical infrastructure assets in accordance with one embodiment.

FIG. 4 illustrates an asset map user interface 400 in accordance with one embodiment.

FIG. 5 illustrates an asset map user interface 400 in accordance with one embodiment.

FIG. 6 illustrates an asset map user interface 600 in accordance with one embodiment.

FIG. 7 illustrates an asset map user interface 700 in accordance with one embodiment.

FIG. 8 illustrates an asset map user interface 800 in accordance with one embodiment.

FIG. 9 illustrates an asset map user interface 800 in accordance with one embodiment.

FIG. 10 illustrates an asset map user interface 1000 in accordance with one embodiment.

FIG. 11 illustrates an asset map user interface 1100 in accordance with one embodiment.

FIG. 12 illustrates an asset map user interface 1200 in accordance with one embodiment.

FIG. 13 illustrates a user interface 1300 in accordance with one embodiment.

FIG. 14 illustrates a user interface 1400 in accordance with one embodiment.

FIG. 15 illustrates a user interface 1500 in accordance with one embodiment.

FIG. 16 illustrates a user interface 1600 in accordance with one embodiment.

FIG. 17 illustrates a user interface 1600 in accordance with one embodiment.

FIG. 18 illustrates a user interface 1800 in accordance with one embodiment.

FIG. 19 illustrates a simplified system 1900 in which a server 1904 and a client device 1906 are communicatively coupled via a network 1902.

FIG. 20 illustrates a system 2000 in accordance with one embodiment.

FIG. 21 is an example block diagram of a computing device 2100 that may incorporate embodiments of the present invention.

### DETAILED DESCRIPTION

A system and method for visualization of geospatial positioning and management of electrical infrastructure assets is an online geospatial data platform, uniquely tailored to the electrical utility industry's needs. With the increasing amounts of digital data being used for inspection and mapping of utility infrastructure, the system and method provides electrical utility companies with the tools to import, visualize, annotate and create reports from a wide variety of data types and sources.

In some configurations, the system and method visualizes image collections of electrical assets with geospatial data. The image collections may be uploaded to a server for access by a data visualization engine. The system and method operates a geographical information system layer to visualize the data.

A method for visualization of geospatial positioning and management of electrical infrastructure assets involves receiving a data set comprising visual data, spatiotemporal data, geo-positional data, and point cloud data corresponding to at least one infrastructure asset and assigning the data set to a data pool through operation of an ingestion engine. The method maps the visual data, the spatiotemporal data, and the point cloud data for the at least one infrastructure asset to a geographic information system as at least one virtual asset through operation of a mapping engine configured by the geo-positional data for the at least one infrastructure asset. The method visualizes the at least one virtual asset with a placemark on virtual geographic map through an asset map user interface through operation of a data visualization engine. The method displays the visual data, the spatiotemporal data, the geo-positional data, and the point cloud data for the at least one virtual asset in response to selecting the placemark on the asset map user interface. The method applies severity annotations to the at least one virtual asset through an annotations menu displayed on the asset inspector user interface. The method groups the at least one virtual asset with at least one other virtual asset based on proximity of the placemark on the virtual geographic map through operation of an image grouper. The method generates an encroachment report comprising encroachment severity from the point cloud data of the at least one infrastructure assets in the data pool through operation of an encroachment analyzer. The method generates an assets report comprising the severity annotations and the encroachment report for the at least one infrastructure asset in the data pool through operation of a reporting tool.

In an embodiment, the method further involves a dashboard user interface displaying data pool statistics comprising the severity annotations and the encroachment severity of the at least one infrastructure assets in the data pool. The dashboard user interface further displays the asset inspector user interfaces, the encroachment analyzer, and the image grouper through the operations overlay.

In an embodiment, the encroachment analyzer is configured with measurements between points in a point cloud.

In an embodiment, the at least one virtual asset is associated with a plurality of visual data representing the at least one infrastructure asset from different angles.

In an embodiment, the data set represents a series of infrastructure assets between two geo-positional locations.

In an embodiment, the virtual geographic map is represented as a two dimensional map.

In an embodiment, the virtual geographic map is represented as a three dimensional map.

A computing apparatus includes a processor and a memory storing instructions that, when executed by the processor, configure the apparatus to receive a data set comprising visual data, spatiotemporal data, geo-positional data, and point cloud data corresponding to at least one infrastructure asset and assigning the data set to a data pool through operation of an ingestion engine. The instructions configure the apparatus to map the visual data, the spatiotemporal data, and the point cloud data for the at least one infrastructure asset to a geographic information system as at least one virtual asset through operation of a mapping engine configured by the geo-positional data for the at least one infrastructure asset. The instructions configure the apparatus to visualize the at least one virtual asset with a placemark on virtual geographic map through an asset map user interface through operation of a data visualization engine. The instructions configure the apparatus to display the visual data, the spatiotemporal data, the geo-positional data, and the point cloud data for the at least one virtual asset in response to selecting the placemark on the asset map user interface. The instructions configure the apparatus to apply severity annotations to the at least one virtual asset through an annotations menu displayed on the asset inspector user interface. The instructions configure the apparatus to group the at least one virtual asset with at least one other virtual asset based on proximity of the placemark on the virtual geographic map through operation of an image grouper. The instructions configure the apparatus to generate an encroachment report comprising encroachment severity from the point cloud data of the at least one infrastructure assets in the data pool through operation of an encroachment analyzer. The instructions configure the apparatus to generate an assets report comprising the severity annotations and the encroachment report for the at least one infrastructure asset in the data pool through operation of a reporting tool.

In an embodiment, the instructions further configure the apparatus to include a dashboard user interface display data pool statistics comprising the severity annotations and the encroachment severity of the at least one infrastructure assets in the data pool. The dashboard user interface further displays the asset inspector user interfaces, the encroachment analyzer, and the image grouper through the operations overlay.

In an embodiment, the encroachment analyzer is configured with measurements between points in a point cloud.

In an embodiment, the at least one virtual asset is associated with a plurality of visual data representing the at least one infrastructure asset from different angles.

In an embodiment, the data set represents a series of infrastructure assets between two geo-positional locations.

In an embodiment, the virtual geographic map is represented as a two dimensional map.

In an embodiment, the virtual geographic map is represented as a three dimensional map.

A non-transitory computer-readable storage medium, the computer-readable storage medium including instructions that when executed by a computer, cause the computer to receive a data set comprising visual data, spatiotemporal data, geo-positional data, and point cloud data corresponding to at least one infrastructure asset and assigning the data set to a data pool through operation of an ingestion engine. When executed the instructions cause the computer to map the visual data, the spatiotemporal data, and the point cloud data for the at least one infrastructure asset to a geographic information system as at least one virtual asset through operation of a mapping engine configured by the geo-positional data for the at least one infrastructure asset. When executed the instructions cause the computer to visualize the at least one virtual asset with a placemark on virtual geographic map through an asset map user interface through operation of a data visualization engine. When executed the instructions cause the computer to display the visual data, the spatiotemporal data, the geo-positional data, and the point cloud data for the at least one virtual asset in response to selecting the placemark on the asset map user interface. When executed the instructions cause the computer to apply severity annotations to the at least one virtual asset through an annotations menu displayed on the asset inspector user interface. When executed the instructions cause the computer to group the at least one virtual asset with at least one other virtual asset based on proximity of the placemark on the virtual geographic map through operation of an image grouper. When executed the instructions cause the computer to generate an encroachment report comprising encroachment severity from the point cloud data of the at least one infrastructure assets in the data pool through operation of an encroachment analyzer. When executed the instructions cause the computer to generate an assets report comprising the severity annotations and the encroachment report for the at least one infrastructure asset in the data pool through operation of a reporting tool.

In an embodiment, when executed the instructions further cause the computer to include a dashboard user interface display data pool statistics comprising the severity annotations and the encroachment severity of the at least one infrastructure assets in the data pool. The dashboard user interface further displays the asset inspector user interfaces, the encroachment analyzer, and the image grouper.

In an embodiment, the encroachment analyzer is configured with measurements between points in a point cloud.

In an embodiment, the at least one virtual asset is associated with a plurality of visual data representing the at least one infrastructure asset from different angles.

In an embodiment, the data set represents a series of infrastructure assets between two geo-positional locations.

In an embodiment, the virtual geographic map is represented as a two dimensional map.

In an embodiment, the virtual geographic map is represented as a three dimensional map.

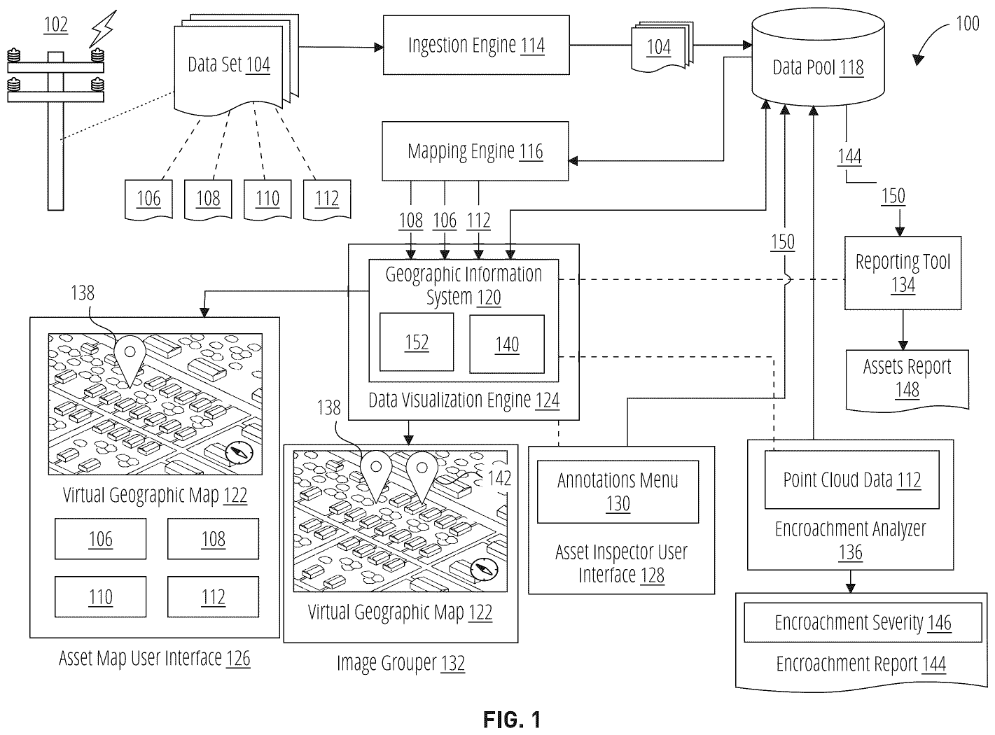

FIG. 1 illustrates a system 100 for visualization of geospatial positioning and management of electrical infrastructure assets. The system 100 comprises an ingestion engine 114, a mapping engine 116, a data pool 118, a geographic information system 120, an asset map user interface 126, a virtual geographic map 122, a data visualization engine 124 an image grouper 132, an asset inspector user interface 128, a reporting tool 134, and an encroachment analyzer 136. During operation of the system 100, a data set 104 for at least one infrastructure asset 102 is provided to an ingestion engine 114. Each infrastructure asset in the data set 104 may include visual data 106, spatiotemporal data 108, geo-positional data 110, and point cloud data 112. The data set 104 is assigned to the data pool 118 through operation of the ingestion engine 114. The spatiotemporal data 108, the visual data 106, and the point cloud data 112 for the at least one infrastructure asset 102 are mapped to a geographic information system 120 as at least one virtual asset 140 through operation of the mapping engine 116 configured by the geo-positional data 110 for the at least one infrastructure asset 102. The system 100 visualizes the at least one virtual asset 140 with a placemark 138 on virtual geographic map 122 through an asset map user interface 126. The system 100 displays the visual data 106, the spatiotemporal data 108, the geo-positional data 110, and the point cloud data 112 for the at least one virtual asset 140 in response to selecting the placemark 138 on the asset map user interface 126. The system 100 applies severity annotations 150 to the at least one virtual asset 140 through an annotations menu 130 displayed on the asset inspector user interface 128. The severity annotations 150 may also be communicated and stored with the at least one virtual asset 140 with the data set 104 in the data pool 118 for use by the reporting tool 134. The system 100 group the at least one virtual asset 140 with at least one other virtual asset 152 based on proximity of the placemark 138 for the at least one virtual asset 140 and the placemark 142 on the virtual geographic map 122 through operation of an image grouper 132. The system 100 generates an assets report 148 comprising the severity annotations 150 for the at least one infrastructure asset 102 in the data pool 118 through operation of a reporting tool 134. The system 100 generates an encroachment report 144 comprising encroachment severity 146 from the point cloud data 112 of the at least one infrastructure assets 102 in the data pool 118 through operation of an encroachment analyzer 136.

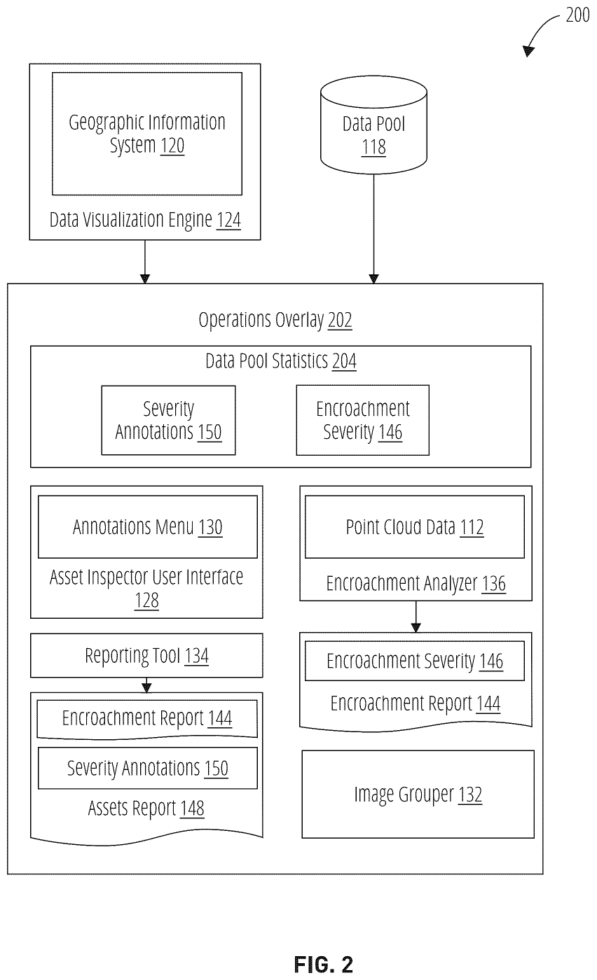

FIG. 2 illustrates a system 200 for visualization of geospatial positioning and management of electrical infrastructure assets. The system 200 includes an operations overlay 202 communicably coupled to the data visualization engine 124, the geographic information system 120, and the data pool 118. The operations overlay 202 displays data pool statistics 204 for at least one infrastructure asset in the data pool 118. The data pool statistics 204 may also display the data pool statistics 204 for data sets in the data pool 118 where infrastructure assets may be grouped by data sets where they were introduced into the data pool or through other properties such as their geo-positional data. The operations overlay 202 may also function to display the asset inspector user interface 128 showing the annotations menu 130, the encroachment analyzer 136 displaying point cloud data 112 for at least one infrastructure asset and generating an encroachment report 144 comprising encroachment severity 146. The reporting tool 134 generating assets report 148 comprising an encroachment report 144 and severity annotations 150. the operations overlay 202 may also display the image grouper 132 with a list of virtual assets to group based on proximity of placemarks on a virtual geographic map.

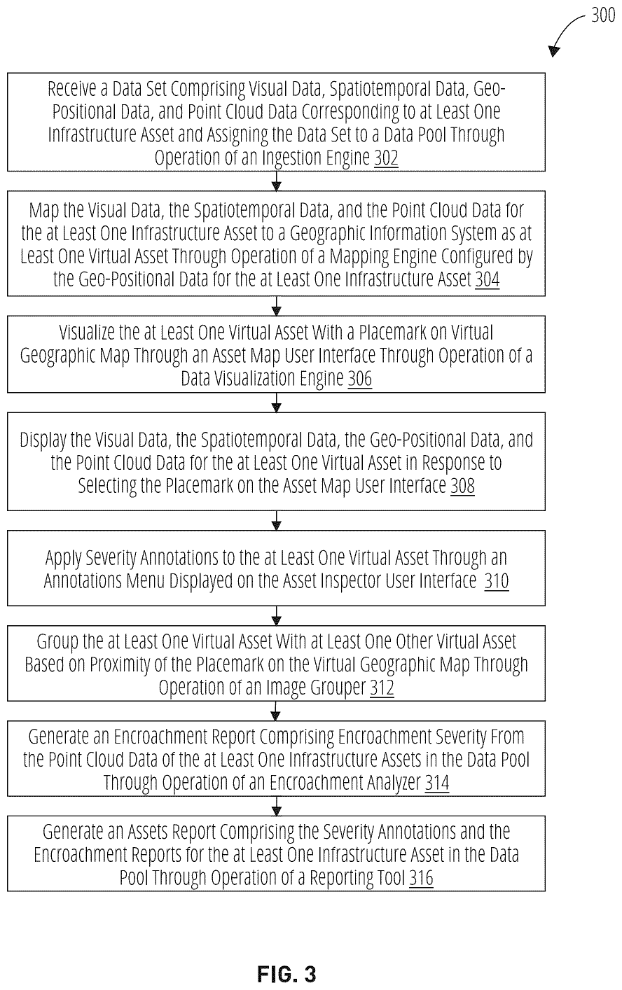

FIG. 3 illustrates a method 300 for the visualization of geospatial positioning and management of electrical infrastructure assets in accordance with one embodiment. In block 302, the method 300 receives a data set comprising visual data, spatiotemporal data, geo-positional data, and point cloud data corresponding to at least one infrastructure asset and assigning the data set to a data pool through operation of an ingestion engine. In block 304, the method 300 maps the visual data, the spatiotemporal data, and the point cloud data for the at least one infrastructure asset to a geographic information system as at least one virtual asset through operation of a mapping engine configured by the geo-positional data for the at least one infrastructure asset. In block 306, the method 300 visualizes the at least one virtual asset with a placemark on virtual geographic map through an asset map user interface through operation of a data visualization engine. In block 308, the method 300 displays the visual data, the spatiotemporal data, the geo-positional data, and the point cloud data for the at least one virtual asset in response to selecting the placemark on the asset map user interface. In block 310, the method 300 applies severity annotations to the at least one virtual asset through an annotations menu displayed on the asset inspector user interface. In block 312, the method 300 groups the at least one virtual asset with at least one other virtual asset based on proximity of the placemark on the virtual geographic map through operation of an image grouper. In block 314, the method 300 generates an encroachment report comprising encroachment severity from the point cloud data of the at least one infrastructure assets in the data pool through operation of an encroachment analyzer. In block 316, the method 300 generates an assets report comprising the severity annotations and the encroachment reports for the at least one infrastructure assets in the data pool through operation of a reporting tool.

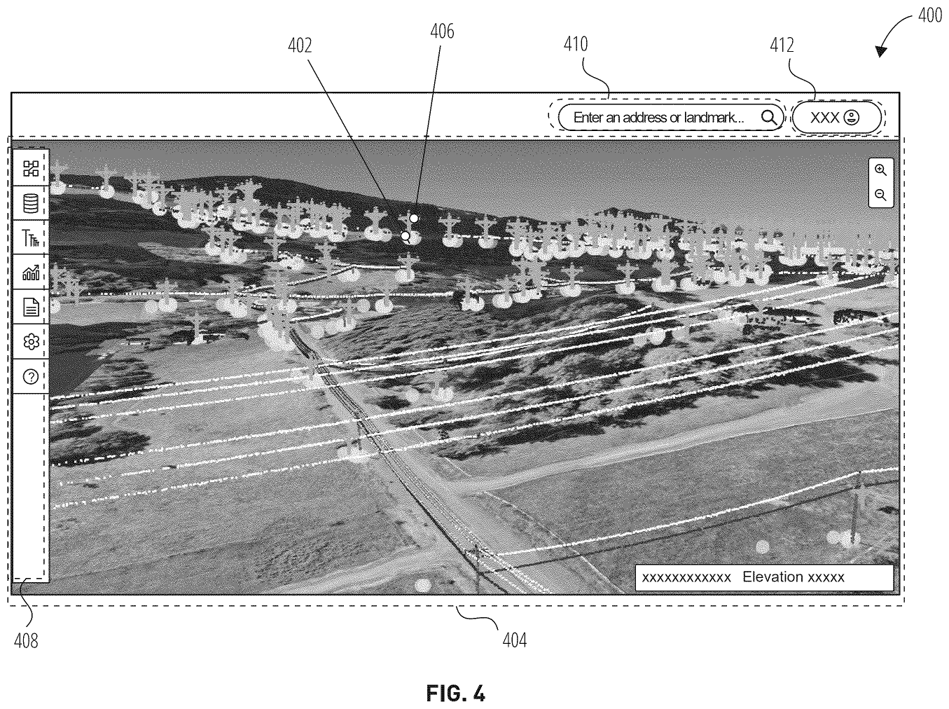

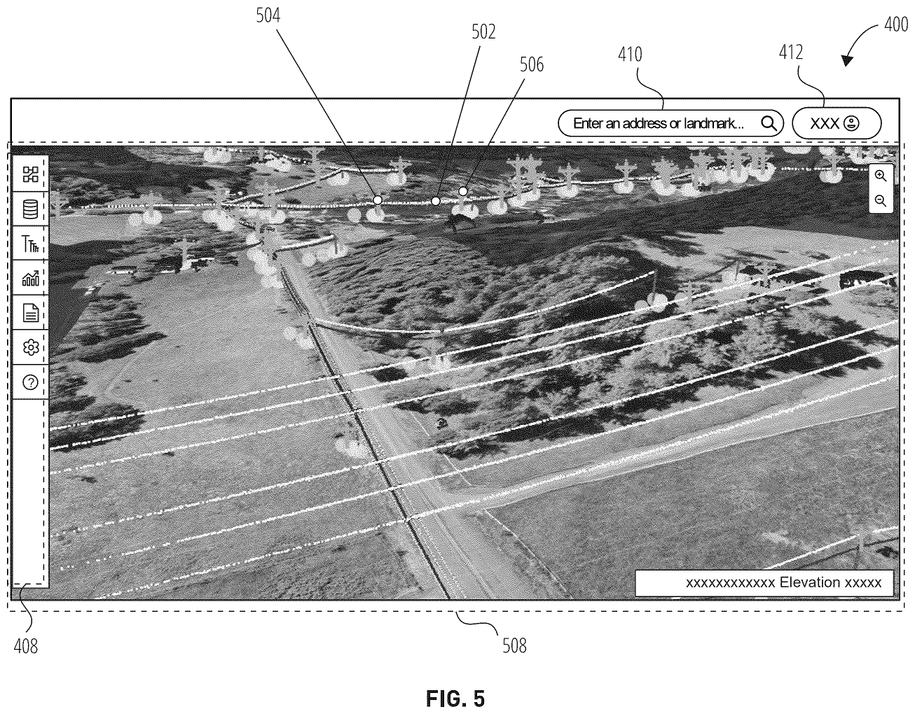

FIG. 4 and FIG. 5 illustrates an asset map user interface 400 showing a virtual geographic map 404 showing placemark 402 and at least one virtual asset 406. The asset map user interface 400 include a navigations bar 408 with links for Home, Support, Pricing, Contact and Login. After a user logs in, they are able to access the asset map user interface 400 with the virtual geographic map 404 displaying the placemark 402 for the at least one virtual asset 406. The virtual geographic map 404 may include functionality such as 3D globe that allows user to pan, tilt and zoom navigation via mouse with scroll wheel, similar to Google Earth, pan navigation via arrow keys in order to travel long distances smoothly, similar to Google Earth, basic measuring tools for measuring ortho and LiDAR data manually, similar to Google Earth, buttons to change map styles from satellite view to street view etc., compass rose that shows orientation and allows user to rest view, similar to Google Earth, an annotations button with multiple styles of annotation to select, a search bar 410 for searching for locations or pole names on map, and a menu buttons which allow user access to their data and the more advanced features of the system and method for visualization of geospatial positioning and management of electrical infrastructure assets. In addition, the asset map user interface 400 may include an accounts button 412 that when selected displays profile information and the ability to edit profile information, manage users and logout.

In FIG. 5, the asset map user interface 400 shows another view of the virtual geographic map 508 showing a power line 502 overlay connecting virtual asset 504 and virtual asset 506.

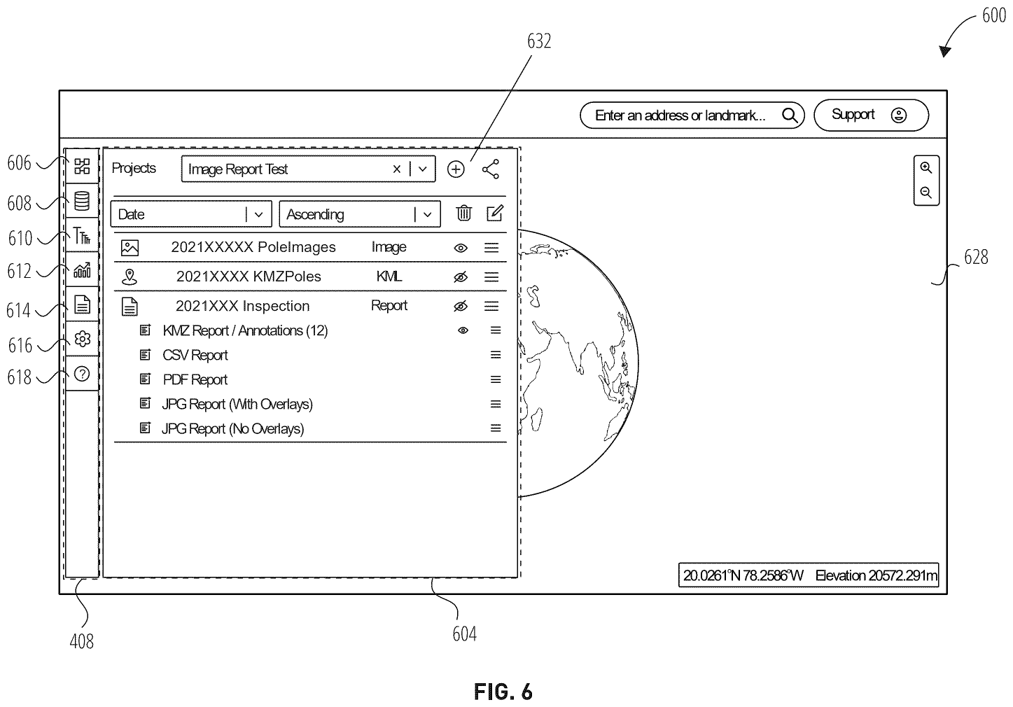

FIG. 6 illustrates an asset map user interface 600 for the system and method for visualization of geospatial positioning and management of electrical infrastructure assets showing a 3D globe for the virtual geographic map 628 and navigations bar 408 with an operations overlay 604 above the virtual geographic map 628. The asset map user interface 600 shows further interactions with the navigations bar 408. The navigations bar 408 comprises a projects button 606, a data sets button 608, an assets manager button 610, a dashboard button 612, tools button 614, a settings button 616, and a support button 618. Selection of the any of the buttons from the navigations bar 408 launches an operations overlay 604 on top of the virtual geographic map 628. In the asset map user interface 600, the operations overlay 604 is launched after the projects button 606 is selected showing a reporting tool 632. The reporting tool 632 may show a list of projects that can be selected to view based on the data sets that have been added to the project. When a project is opened, any datasets in the current project can have visualization turned on/off, can be downloaded and in some cases, can have some additional view settings adjusted. Files added or deleted from the projects'view will not affect the data sets in the data sets 702 menu.

When the assets manager button 610 is selected the operations overlay may show a list of assets (GIS placemarks) with names, attributes and locations for each pole or asset. Assets can be searched, sorted, filtered, created or edited and user can also click to fly to specific assets on the map. This asset list is used for visual reference and for reference of the automated REPORTS capabilities the system and method for visualization of geospatial positioning and management of electrical infrastructure assets.

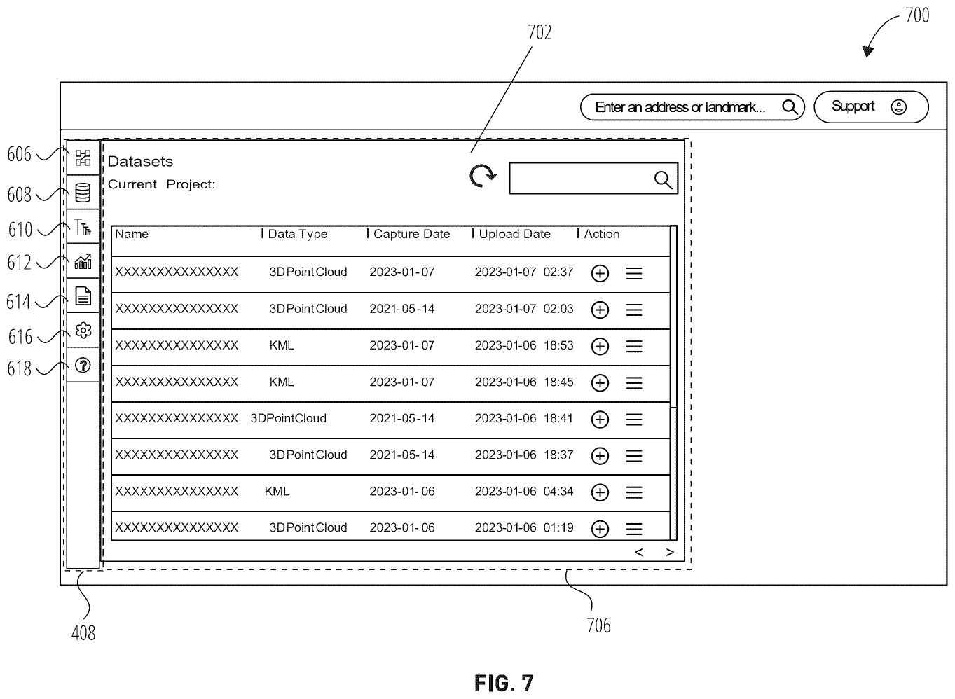

FIG. 7 illustrates an asset map user interface 700 displaying an operations overlay 706 with showing a data sets 702 in the data pool after the data sets button 608 is selected. The operations overlay 706 is a datasets view that lists the data sets that have been uploaded to the system and method for visualization of geospatial positioning and management of electrical infrastructure assets'servers under the user account. Data sets be added to current project, edited or deleted from server.

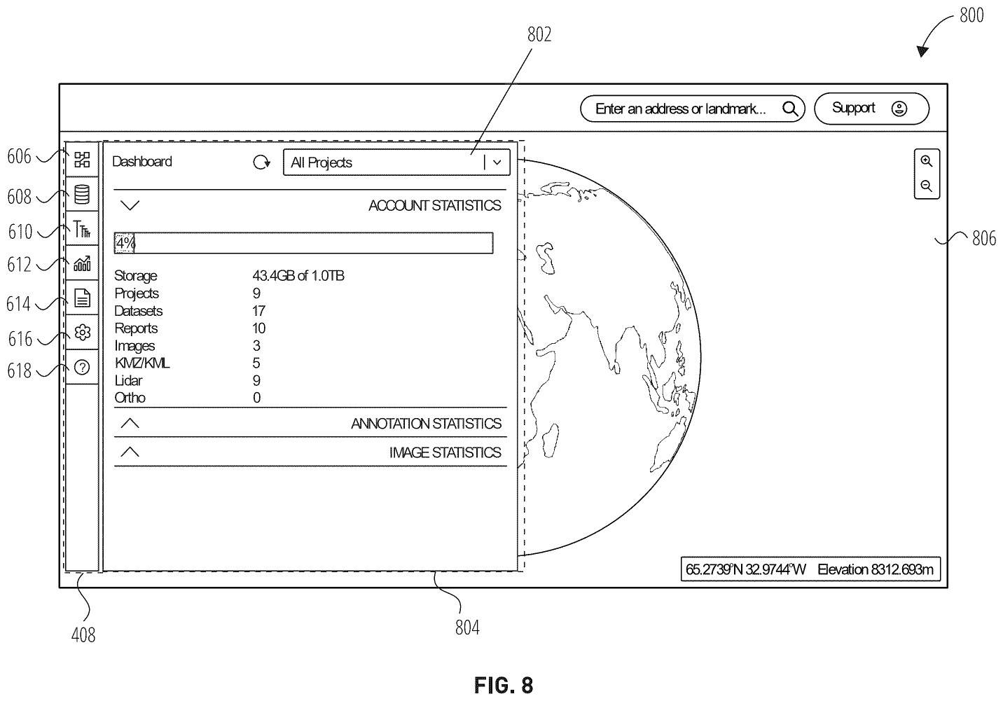

FIG. 8 illustrates an asset map user interface 800 displaying an operations overlay 804 with a dashboard 802 following the selection of the dashboard button 612 from the navigations bar 408. The operations overlay 804 is placed over a 3D Globe view of the virtual geographic map 806. When the dashboard button 612 is clicked, the operations overlay 804 shows information and statistics of the data in the user's account such as storage used, storage available, quantity of specific types of data, inspection statistics etc. and utilizes text and graphics to depict said statistics. The dashboard 802 shows data specifically for assets in the data pool associated with the user's account

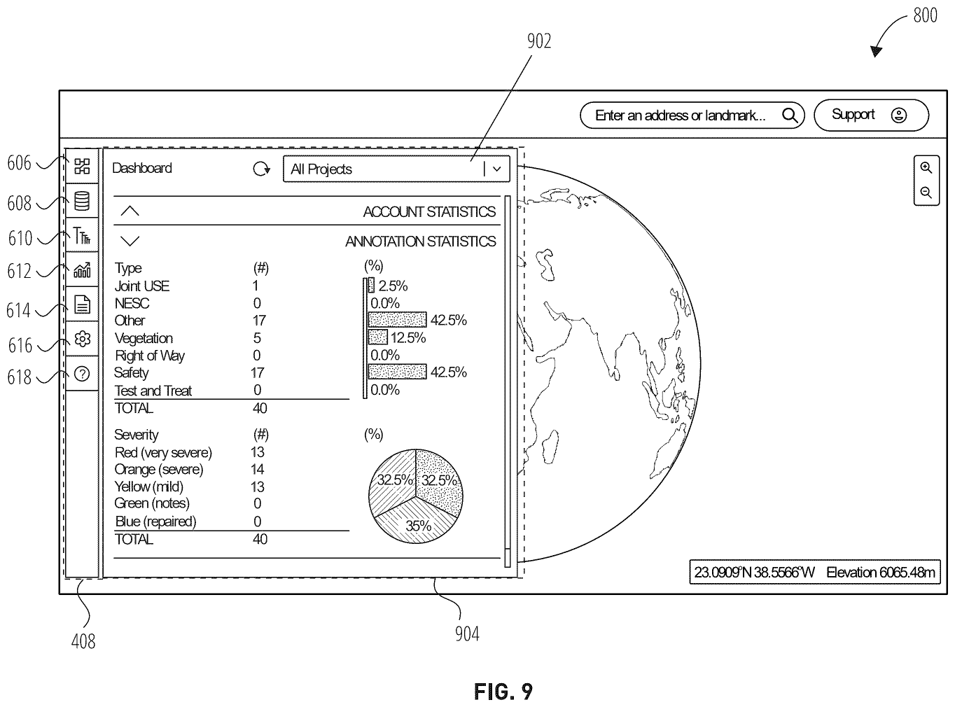

FIG. 9 illustrates the asset map user interface 800 showing additional data visualizations an operations overlay 904 of a dashboard 902 for the user account's data pool.

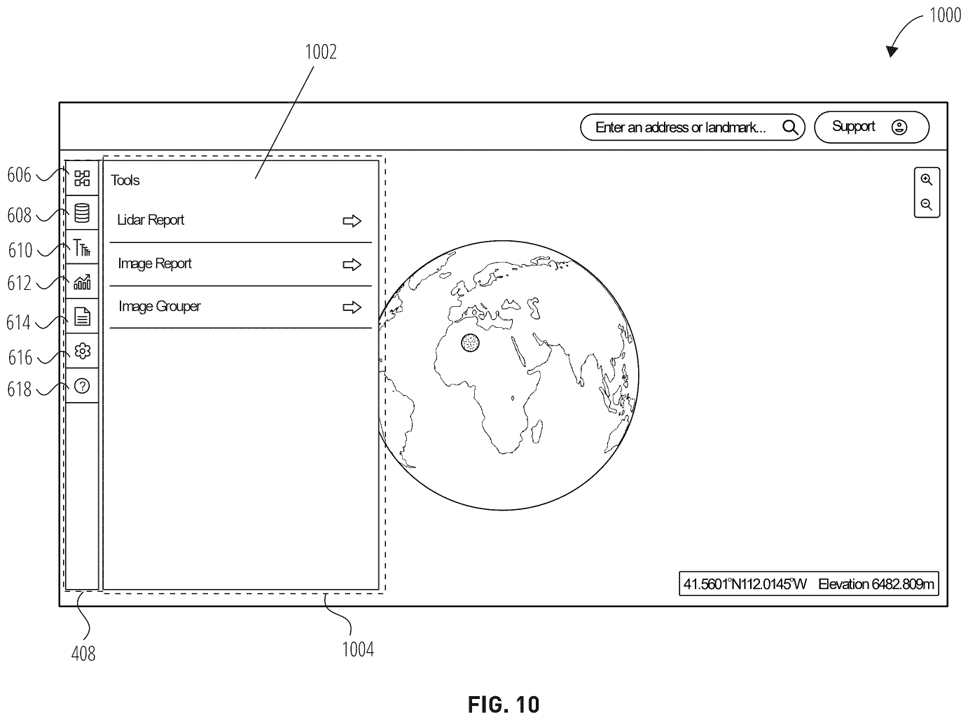

FIG. 10 illustrates an asset map user interface 1000 displaying an operations overlay 1004 showing a tools menu 1002 following the selection of the tools button 614 from the navigations bar 408. The tools menu 1002 shows options for generating a lidar report, an image report, and the image grouper. The tools menu 1002 lists the automated tools that are capable of processing the data sets. Some of the tools that may be included in the tools menu 1002 include an Image Report Tool, LiDAR Report Tool, Image Grouper etc. . . . and however additional tools may be added for additional data reporting.

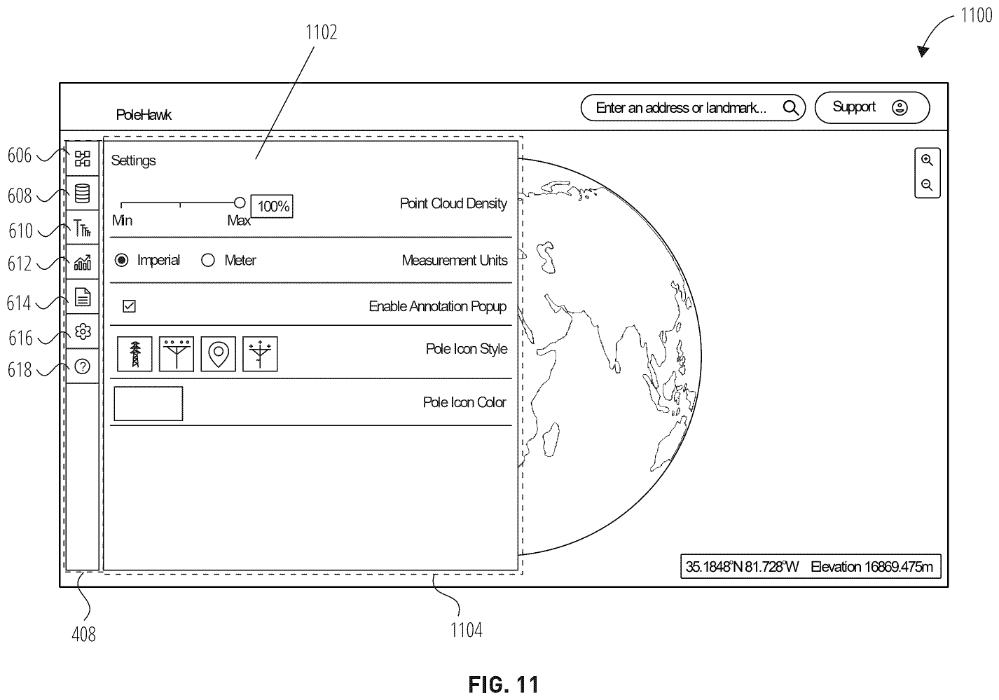

FIG. 11 shows an asset map user interface 1100 displaying an operations overlay 1104 with a settings menu 1102 after the settings button 616 is selected from the navigations bar 408. The settings menu 1102 shows a list of settings for the user's account. Setting can be defaults, visualization, LiDAR class code visualization on/off, LiDAR class colors, LiDAR class names, LiDAR point size, Image icon styles or colors, Image icon visualization on/off, KMZ/KML data placemark icons style and color etc. All settings are saved for future reference

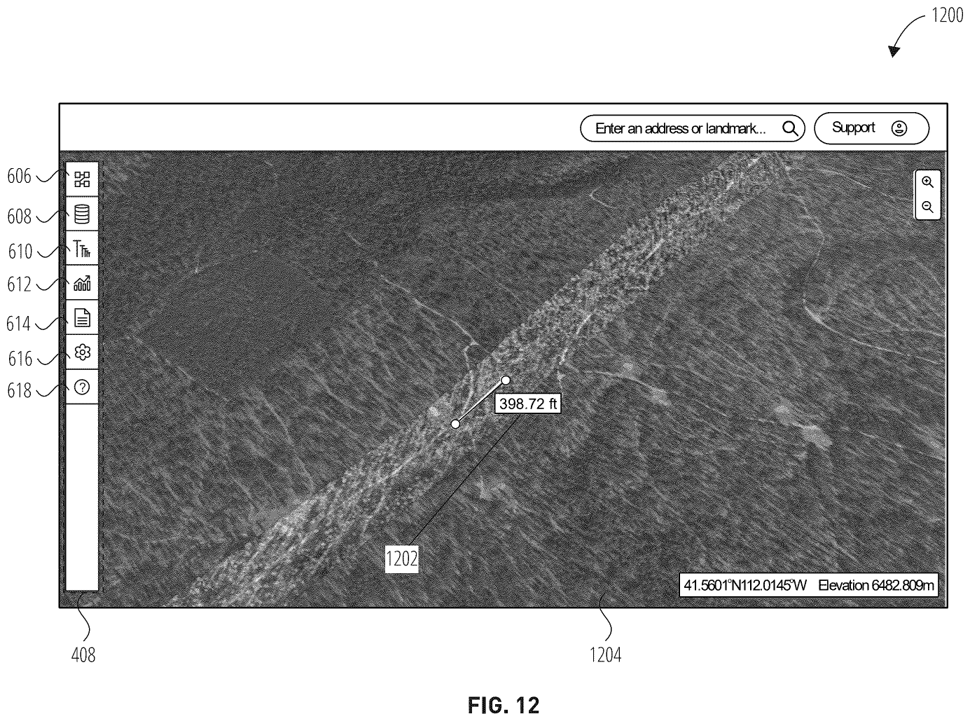

FIG. 12 illustrates an asset map user interface 1200 showing a virtual geographic map 1204 with a map annotation 1202. The system and method for visualization of geospatial positioning and management of electrical infrastructure assets has the ability to allow user to create map annotations in the virtual geographic map 1204 of the asset map user interface 1200. The map annotation 1202 are any annotations that are created in the MAP VIEW and can be 2D or 3D and may contain annotation style, type, severity, name, comments and measurement details. When annotations are created, a new DATASET may be created in the current PROJECT to contain the ANNOTATIONS.

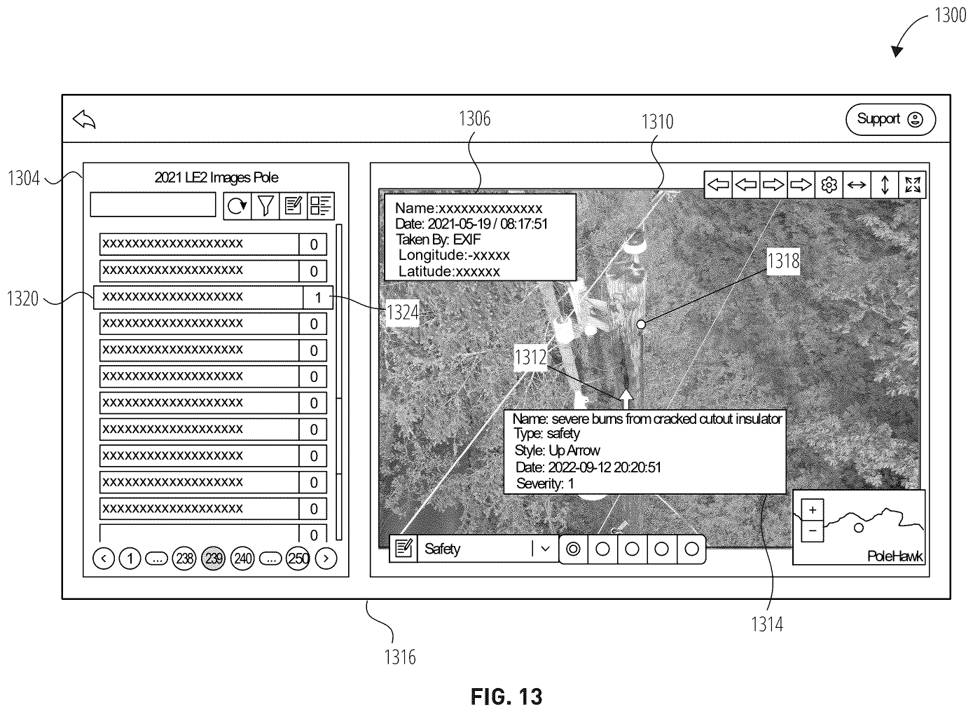

FIG. 13 illustrates a user interface 1300 showing for an image inspector user interface 1316. The image inspector user interface 1316 includes an image list 1304 and an image 1310 of an infrastructure asset 1318. The image inspector user interface 1316 shows the image list 1304 and a highlighted selected asset 1320 showing a number indicating an annotation 1324. When selected the image 1310 is shown of the infrastructure asset 1318 showing the asset details 1306 and an annotation 1314 with an indicator 1312 showing the exact problem.

In addition to the virtual geographic map view which is used primarily for viewing locations, layouts, measurements etc. for images, GIS, LiDAR ortho imagery. The system and method for visualization of geospatial positioning and management of electrical infrastructure assets includes an image inspector user interface 1316 which is used for viewing, searching and annotating inspection imagery. The image inspector user interface 1316 can be accessed by clicking an image on the map or through a menu button. Some of the features that the image inspector user interface 1316 includes but is not limited to are a list of images with text view or thumbnail view, Image preview window, Image search and filter features, Image annotation controls including annotation style, type, severity, name and comments, Image navigation and viewing controls.

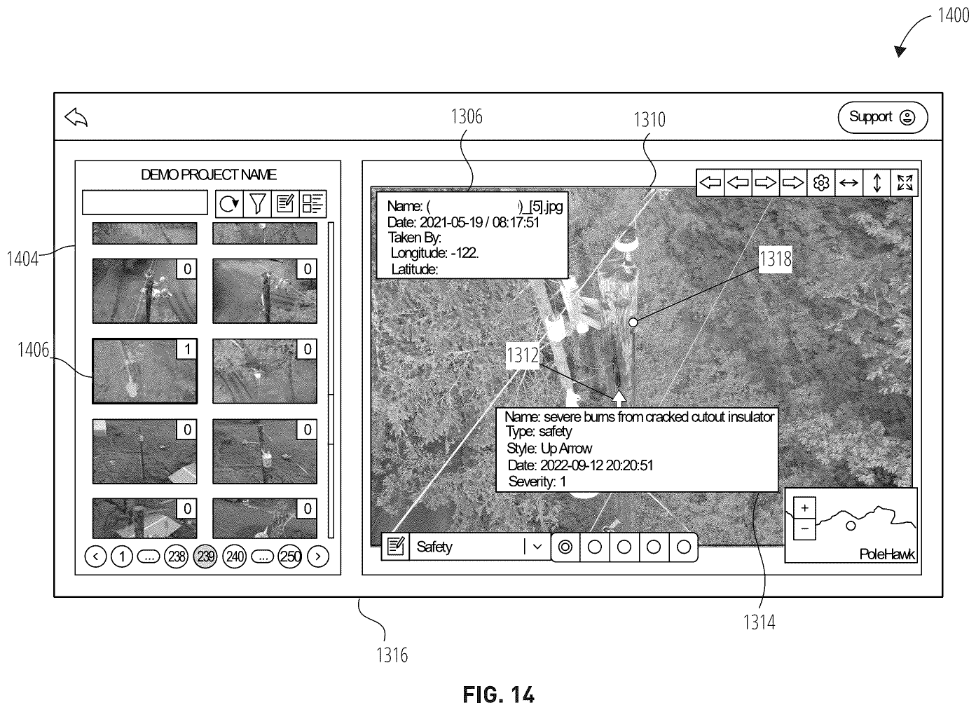

FIG. 14 illustrates a user interface 1400 showing an additional menu variation of the image inspector user interface 1316 showing an image view 1404 showing thumbnail views of the infrastructure assets. Similar to the user interface 1300 selecting the asset details 1306 displays the image 1310 of the infrastructure asset 1318 displaying the asset details 1306 and the annotation 1314.

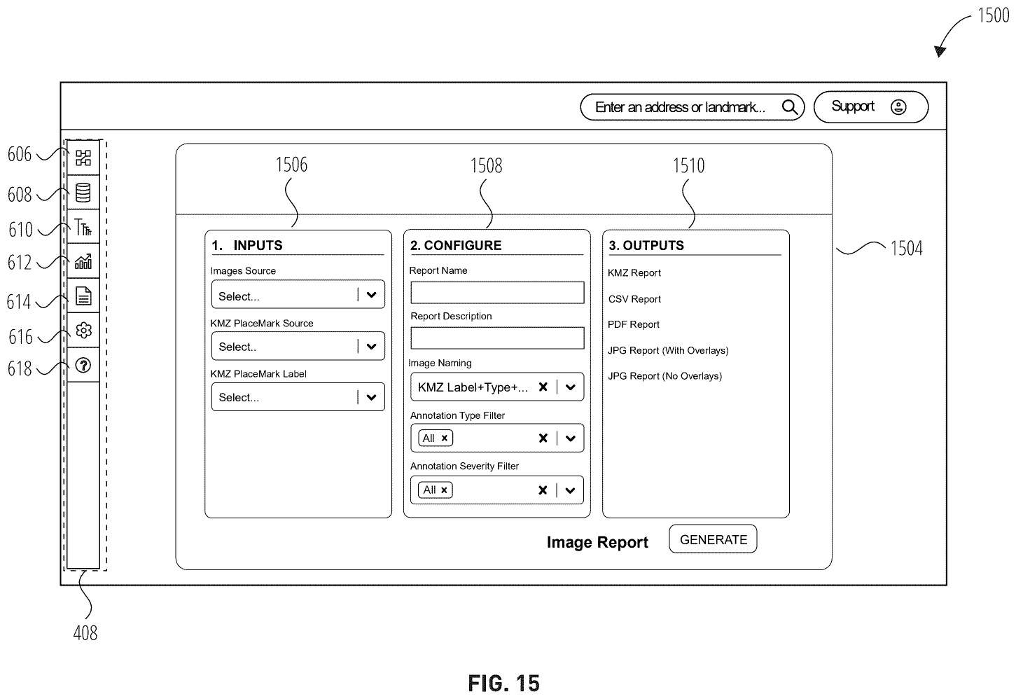

FIG. 15 illustrates a user interface 1500 showing an image report tool 1504 shown after selecting image report from the tools menu 1002. The IMAGE REPORT TOOL image report tools 1504 is used for creating reports based on image annotations. The image report tool 1504 comprises an input menu 1506 for selecting data sources, a configuration menu 1508 for configuring the report name, and an output menu 1510 for configuring the output type. When clicked, a popup occurs with inputs for report name, dataset selection, KMZ reference selection as well as configurations and filters. Once inputs and configurations are set, user will click generate button and the report will be created in the current project for viewing, analyzing and downloading. The report outputs may include outputs such as PDF, CSV, JPG, and KMZ.

The PDF output creates a PDF with overview, index, and details sections. The overview section provides basic report information and statistics as well as an overview map with annotations and the report configuration. The Index section provides a table with a list of the annotations, nearest pole names (based on reference KMZ) and annotation severity with color codes. The details section includes 1 page per annotation with a table containing annotation details and statistics, an image with annotation overlays and a map showing the location of the annotation in relation to KMZ placemarks and other annotations.

The CSV output creates a CSV with an overview header and a table of details below. The overview section provides basic report information and statistics and the report configuration. The details section provides a table with a list of the annotations, nearest pole names (based on reference KMZ) and a variety of other detailed information regarding the annotation and its associated image.

The JPG report option creates a copy of each annotated image with overlays and without overlays. The images with and without overlays may also be renamed to the nearest pole based on KMZ reference as well.

The KMZ report option would create a KMZ/KML file containing placemarks color coded to match annotation severity in accordance with the specified filters that the user has selected. This KMZ/KML file can be opened in Google Earth or other GIS software.

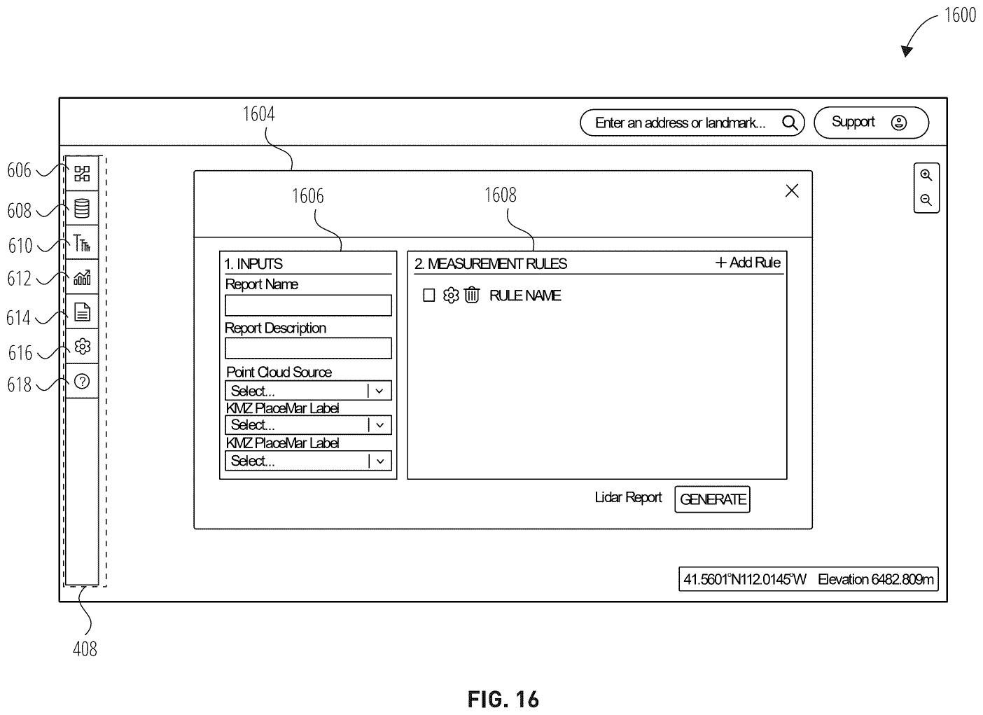

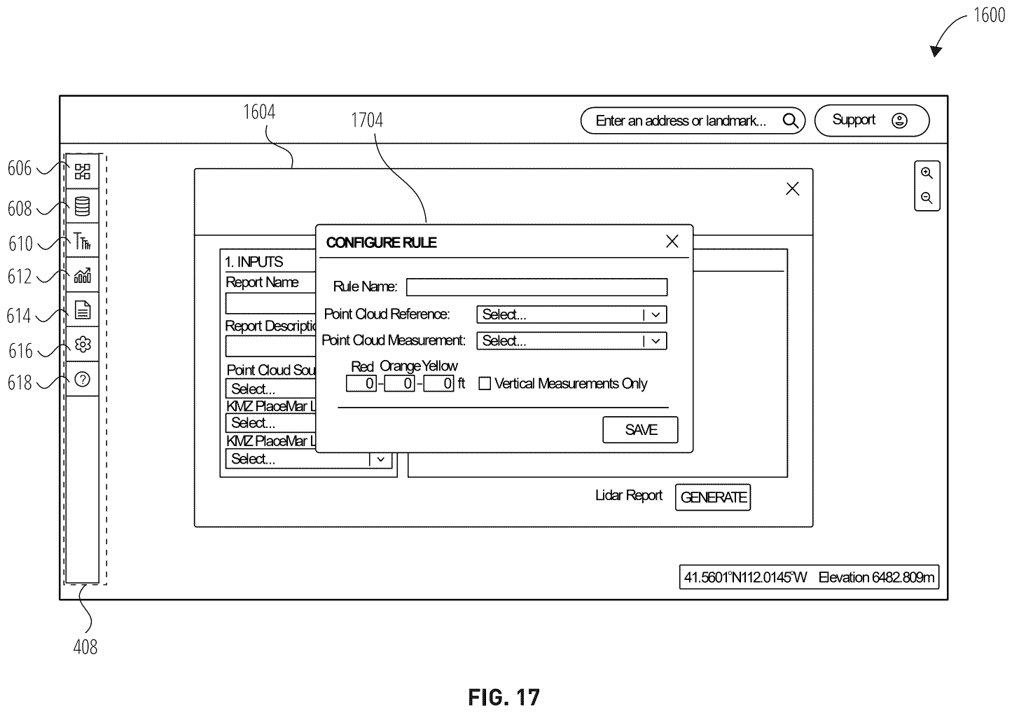

FIG. 16 and FIG. 17 illustrate a user interface 1600 showing a lidar report tool 1604 comprising an input 1606 and a measurement rules 1608. The lidar report tool 1604 is shown following the selection of LiDAR report from the tools menu 1002 following the selection of the tools button 614 from the navigations bar 408. The lidar report tool 1604 is used to generate reports such as vegetation encroachment reports or NESC code compliance reports from LiDAR data. When clicked, a popup occurs with inputs 1606 for report name, dataset selection, KMZ reference selection as well as configurations and filters. Then users can create a list of measurement rules 1608 from the configuration that can be configured with reference class, measurement class, annotation severity distances and other settings in the configuration 1704 menu. Users can select which rules to run for the report and then click generate and the report will be created in the current project for viewing, analyzing and downloading. The report outputs may include outputs such as PDF, CSV, LAS, and KMZ.

The PDF output creates a PDF with overview, index and details sections. The overview section provides basic report information and statistics as well as an overview map with annotations and the report configuration. The Index section provides a table with a list of the annotations, nearest pole names (based on reference KMZ), point density (for volumetric estimations) and annotation measurement distance with severity color codes. The details section includes 1 page per annotation with a table containing annotation details and statistics, a map showing the location of the annotation in relation to KMZ placemarks and other annotations, and a rule name and list of configurations.

The CSV output creates a CSV with overview header and details table. The overview section provides basic report information and statistics as well as the report configuration. The details table contains a list of the annotations, nearest pole names (based on reference KMZ), point density (for volumetric estimations) and annotation measurement distances and rule configurations.

The LAS output creates a separate point cloud containing a copy of any points that meet the criteria of the rules that were selected.

The KMZ report option would create a KMZ/KML file containing placemarks color coded to match annotation severity in accordance with the specified rules selected by the user. This KMZ/KML file can be opened in Google Earth or other GIS software.

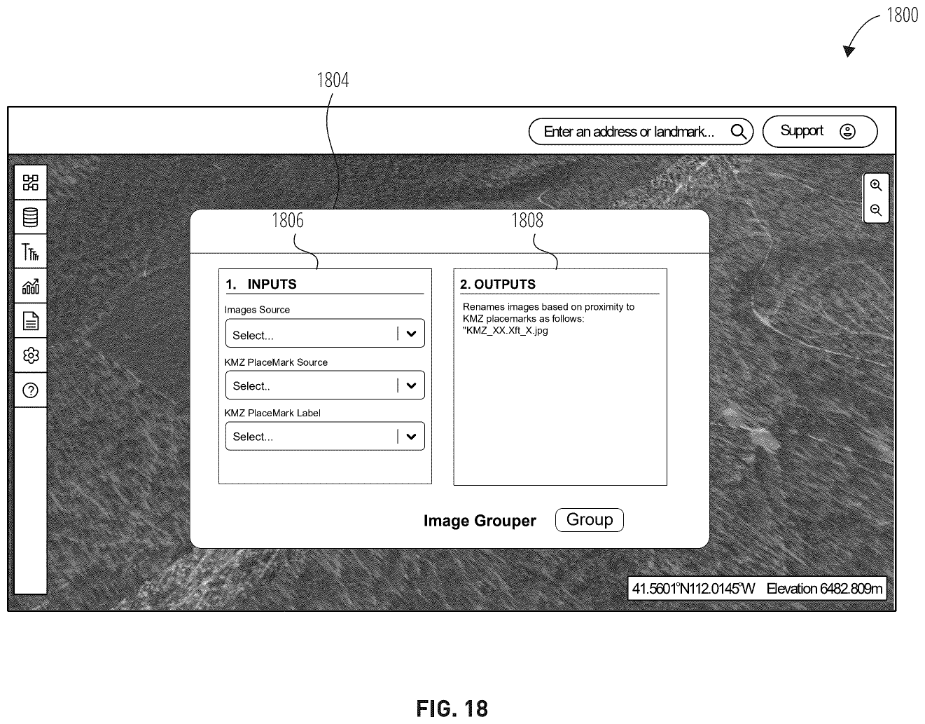

FIG. 18 illustrates a user interface 1800 showing an image grouper 1804. The Image Grouper 1804 is a tool that can be run from the tools menu 1002 to rename images based on KMZ placemark proximity. A user can select image sources, placemark sources, and placemark labels from the inputs 1806 menu. When clicked, a popup will occur and once settings are selected, user can click “Group”and popup will close and images will group in background.

The output names can be configured in the outputs 1808 menu. The Output images will be named as follows: “KMZ_Xft_X. jpg” where “KMZ” is the nearest pole name in the KMZ, “Xft” is the distance between the image and the nearest pole and “X” is the sequence number starting with 1.

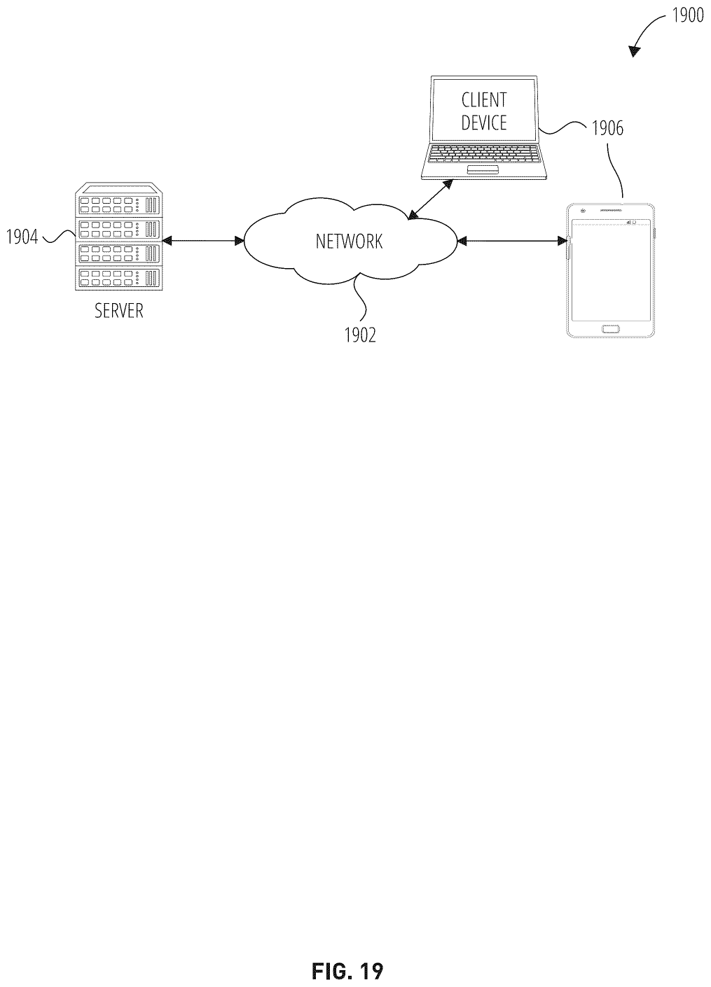

FIG. 19 illustrates a system 1900 in which a server 1904 and a client device 1906 are connected to a network 1902.

In various embodiments, the network 1902 may include the Internet, a local area network (“LAN”), a wide area network (“WAN”), and/or other data network. In addition to traditional data-networking protocols, in some embodiments, data may be communicated according to protocols and/or standards including near field communication (“NFC”), Bluetooth, power-line communication (“PLC”), and the like. In some embodiments, the network 1902 may also include a voice network that conveys not only voice communications, but also non-voice data such as Short Message Service (“SMS”) messages, as well as data communicated via various cellular data communication protocols, and the like.

In various embodiments, the client device 1906 may include desktop PCs, mobile phones, laptops, tablets, wearable computers, or other computing devices that are capable of connecting to the network 1902 and communicating with the server 1904, such as described herein.

In various embodiments, additional infrastructure (e.g., short message service centers, cell sites, routers, gateways, firewalls, and the like), as well as additional devices may be present. Further, in some embodiments, the functions described as being provided by some or all of the server 1904 and the client device 1906 may be implemented via various combinations of physical and/or logical devices. However, it is not necessary to show such infrastructure and implementation details in FIG. 19 in order to describe an illustrative embodiment.

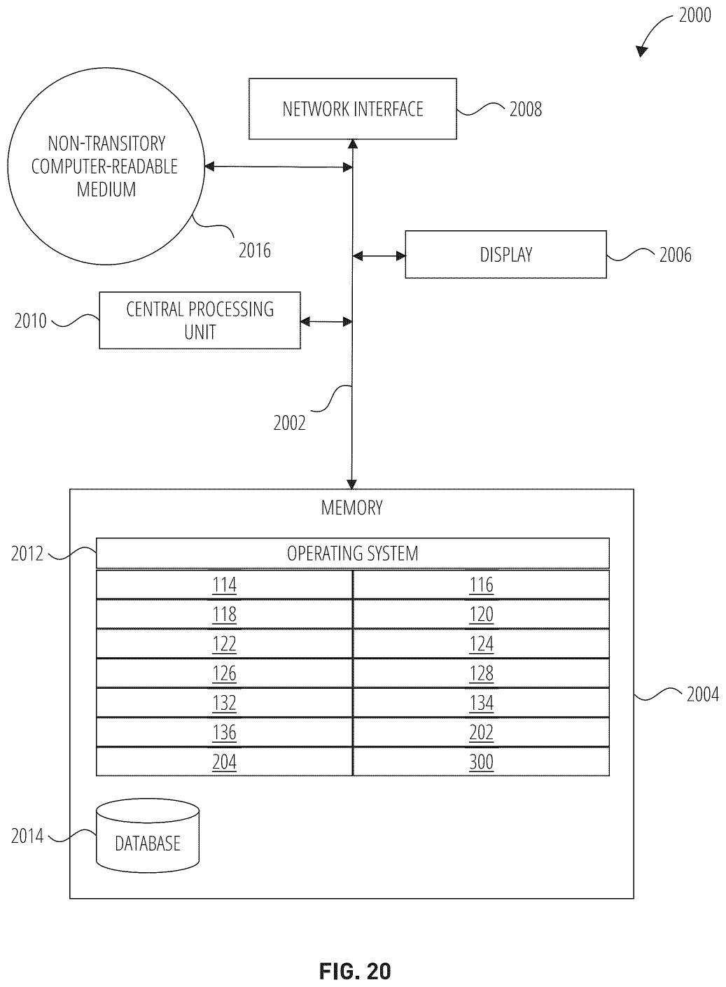

FIG. 20 illustrates several components of an exemplary system 2000 in accordance with one embodiment. In various embodiments, system 2000 may include a desktop PC, server, workstation, mobile phone, laptop, tablet, set-top box, appliance, or other computing device that is capable of performing operations such as those described herein. In some embodiments, system 2000 may include many more components than those shown in FIG. 20. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 2000 may comprise one or more physical and/or logical devices that collectively provide the functionalities described herein. In some embodiments, system 2000 may comprise one or more replicated and/or distributed physical or logical devices.

In some embodiments, system 2000 may comprise one or more computing resources provisioned from a “cloud computing” provider, for example, Amazon Elastic Compute Cloud (“Amazon EC2”), provided by Amazon.com, Inc. of Seattle, Washington; Sun Cloud Compute Utility, provided by Sun Microsystems, Inc. of Santa Clara, California; Windows Azure, provided by Microsoft Corporation of Redmond, Washington, and the like.

System 2000 includes a bus 2002 interconnecting several components including a network interface 2008, a display 2006, a central processing unit 2010, and a memory 2004.

Memory 2004 generally comprises a random access memory (“RAM”) and permanent non-transitory mass storage device, such as a hard disk drive or solid-state drive. Memory 2004 stores an operating system 2012. In an embodiment, the memory 2004 includes logic for an ingestion engine 114, a mapping engine 116, a data pool 118, a geographic information system 120, an asset map user interface 126, a virtual geographic map 122, a data visualization engine 124 an image grouper 132, an asset inspector user interface 128, a reporting tool 134, and an encroachment analyzer 136, operations overlay 202, and data pool statistics 204, and method 300.

These and other software components may be loaded into memory 2004 of system 2000 using a drive mechanism (not shown) associated with a non-transitory computer-readable 2016, such as a DVD/CD-ROM drive, memory card, network download, or the like.

Memory 2004 also includes database 2014. In some embodiments, system 2000 may communicate with database 2014 via network interface 2008, a storage area network (“SAN”), a high-speed serial bus, and/or via the other suitable communication technology.

In some embodiments, database 2014 may comprise one or more storage resources provisioned from a “cloud storage” provider, for example, Amazon Simple Storage Service (“Amazon S3”), provided by Amazon.com, Inc. of Seattle, Washington, Google Cloud Storage, provided by Google, Inc. of Mountain View, California, and the like.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

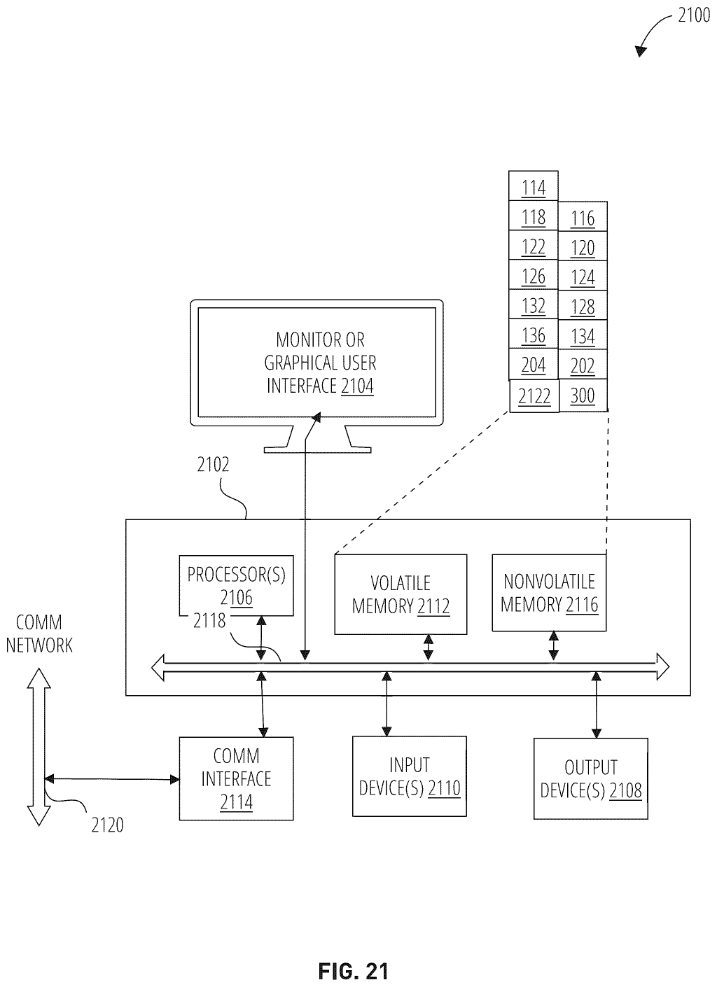

FIG. 21 is an example block diagram of a computing device 2100 that may incorporate embodiments of the present invention. FIG. 21 is merely illustrative of a machine system to carry out aspects of the technical processes described herein, and does not limit the scope of the claims. One of ordinary skill in the art would recognize other variations, modifications, and alternatives. In one embodiment, the computing device 2100 typically includes a monitor or graphical user interface 2104, a data processing system 2102, a communication network interface 2114, input device(s) 2110, output device(s) 2108, and the like.

As depicted in FIG. 21, the data processing system 2102 may include one or more processor(s) 2106 that communicate with a number of peripheral devices via a bus subsystem 2118. These peripheral devices may include input device(s) 2110, output device(s) 2108, communication network interface 2114, and a storage subsystem, such as a volatile memory 2112 and a nonvolatile memory 2116.

The volatile memory 2112 and/or the nonvolatile memory 2116 may store computer-executable instructions and thus forming logic 2122 that when applied to and executed by the processor(s) 2106 implement embodiments of the processes disclosed herein.

The input device(s) 2110 include devices and mechanisms for inputting information to the data processing system 2102. These may include a keyboard, a keypad, a touch screen incorporated into the monitor or graphical user interface 2104, audio input devices such as voice recognition systems, microphones, and other types of input devices. In various embodiments, the input device(s) 2110 may be embodied as a computer mouse, a trackball, a track pad, a joystick, wireless remote, drawing tablet, voice command system, eye tracking system, and the like. The input device(s) 2110 typically allow a user to select objects, icons, control areas, text and the like that appear on the monitor or graphical user interface 2104 via a command such as a click of a button or the like.

The output device(s) 2108 include devices and mechanisms for outputting information from the data processing system 2102. These may include the monitor or graphical user interface 2104, speakers, printers, infrared LEDs, and so on as well understood in the art.

The communication network interface 2114 provides an interface to communication networks (e.g., communication network 2120) and devices external to the data processing system 2102. The communication network interface 2114 may serve as an interface for receiving data from and transmitting data to other systems. Embodiments of the communication network interface 2114 may include an Ethernet interface, a modem (telephone, satellite, cable, ISDN), (asynchronous) digital subscriber line (DSL), FireWire, USB, a wireless communication interface such as BlueTooth or WiFi, a near field communication wireless interface, a cellular interface, and the like.

The communication network interface 2114 may be coupled to the communication network 2120 via an antenna, a cable, or the like. In some embodiments, the communication network interface 2114 may be physically integrated on a circuit board of the data processing system 2102, or in some cases may be implemented in software or firmware, such as “soft modems”, or the like.

The computing device 2100 may include logic that enables communications over a network using protocols such as HTTP, TCP/IP, RTP/RTSP, IPX, UDP and the like.

The volatile memory 2112 and the nonvolatile memory 2116 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 2112 and the nonvolatile memory 2116 may be configured to store the basic programming and data constructs that provide the functionality of the disclosed processes and other embodiments thereof that fall within the scope of the present invention.

Logic 2122 that implements embodiments of the present invention may be stored in the volatile memory 2112 and/or the nonvolatile memory 2116. Said logic 2122 may be read from the volatile memory 2112 and/or nonvolatile memory 2116 and executed by the processor(s) 2106. The volatile memory 2112 and the nonvolatile memory 2116 may also provide a repository for storing data used by the logic 2122.

In an embodiment, the logic 2122 stored in the volatile memory 2112 and the nonvolatile memory 2116 includes logic for an ingestion engine 114, a mapping engine 116, a data pool 118, a geographic information system 120, an asset map user interface 126, a virtual geographic map 122, a data visualization engine 124 an image grouper 132, an asset inspector user interface 128, a reporting tool 134, and an encroachment analyzer 136, operations overlay 202, and data pool statistics 204, and method 300.

The volatile memory 2112 and the nonvolatile memory 2116 may include a number of memories including a main random access memory (RAM) for storage of instructions and data during program execution and a read only memory (ROM) in which read-only non-transitory instructions are stored. The volatile memory 2112 and the nonvolatile memory 2116 may include a file storage subsystem providing persistent (non-volatile) storage for program and data files. The volatile memory 2112 and the nonvolatile memory 2116 may include removable storage systems, such as removable flash memory.

The bus subsystem 2118 provides a mechanism for enabling the various components and subsystems of data processing system 2102 communicate with each other as intended. Although the communication network interface 2114 is depicted schematically as a single bus, some embodiments of the bus subsystem 2118 may utilize multiple distinct busses.

It will be readily apparent to one of ordinary skill in the art that the computing device 2100 may be a device such as a smartphone, a desktop computer, a laptop computer, a rack-mounted computer system, a computer server, or a tablet computer device. As commonly known in the art, the computing device 2100 may be implemented as a collection of multiple networked computing devices. Further, the computing device 2100 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware”in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

What is claimed is:

1. A method for visualization of geospatial positioning and management of electrical infrastructure assets comprises:
receiving a data set comprising visual data, spatiotemporal data, geo-positional data, and point cloud data corresponding to at least one infrastructure asset and assigning the data set to a data pool through operation of an ingestion engine;
mapping the visual data, the spatiotemporal data, and the point cloud data for the at least one infrastructure asset to a geographic information system as at least one virtual asset through operation of a mapping engine configured by the geo-positional data for the at least one infrastructure asset;
visualizing the at least one virtual asset with a placemark on virtual geographic map through an asset map user interface through operation of a data visualization engine;
displaying the visual data, the spatiotemporal data, the geo-positional data, and the point cloud data for the at least one virtual asset in response to selecting the placemark on the asset map user interface;
applying severity annotations to the at least one virtual asset through an annotations menu displayed on the asset inspector user interface;
grouping the at least one virtual asset with at least one other virtual asset based on proximity of the placemark on the virtual geographic map through operation of an image grouper;
generating an encroachment report comprising encroachment severity from the point cloud data of the at least one infrastructure assets in the data pool through operation of an encroachment analyzer; and
generating an assets report comprising the severity annotations and the encroachment reports for the at least one infrastructure asset in the data pool through operation of a reporting tool.

2. The method of claim 1 further comprises an operations overlay displaying data pool statistics comprising the severity annotations and the encroachment severity of the at least one infrastructure assets in the data pool; and
displaying the asset inspector user interfaces, the encroachment analyzer, and the image grouper through the operations overlay.

3. The method of claim 1, wherein the encroachment analyzer is configured with measurements between points in a point cloud.

4. The method of claim 1, wherein the at least one virtual asset is associated with a plurality of visual data representing the at least one infrastructure asset from different angles.

5. The method of claim 1, wherein the data set represents a series of infrastructure assets between two geo-positional locations.

6. The method of claim 1, wherein the virtual geographic map is represented as a two dimensional map.

7. The method of claim 1, wherein the virtual geographic map is represented as a three dimensional map.

8. A computing apparatus comprising:
a processor; and
a memory storing instructions that, when executed by the processor, configure the apparatus to:
receive a data set comprising visual data, spatiotemporal data, geo-positional data, and point cloud data corresponding to at least one infrastructure asset and assigning the data set to a data pool through operation of an ingestion engine;
map the visual data, the spatiotemporal data, and the point cloud data for the at least one infrastructure asset to a geographic information system as at least one virtual asset through operation of a mapping engine configured by the geo-positional data for the at least one infrastructure asset;
visualize the at least one virtual asset with a placemark on virtual geographic map through an asset map user interface through operation of a data visualization engine;
display the visual data, the spatiotemporal data, the geo-positional data, and the point cloud data for the at least one virtual asset in response to selecting the placemark on the asset map user interface;
apply severity annotations to the at least one virtual asset through an annotations menu displayed on the asset inspector user interface;
group the at least one virtual asset with at least one other virtual asset based on proximity of the placemark on the virtual geographic map through operation of an image grouper;
generate an encroachment report comprising encroachment severity from the point cloud data of the at least one infrastructure assets in the data pool through operation of an encroachment analyzer; and
generate an assets report comprising the severity annotations and the encroachment reports for the at least one infrastructure asset in the data pool through operation of a reporting tool.

9. The computing apparatus of claim 8 further comprises an operations overlay display data pool statistics comprising the severity annotations and the encroachment severity of the at least one infrastructure assets in the data pool;
displaying the asset inspector user interfaces, the encroachment analyzer, and the image grouper through the operations overlay.

10. The computing apparatus of claim 8, wherein the encroachment analyzer is configured with measurements between points in a point cloud.

11. The computing apparatus of claim 8, wherein the at least one virtual asset is associated with a plurality of visual data representing the at least one infrastructure asset from different angles.

12. The computing apparatus of claim 8, wherein the data set represents a series of infrastructure assets between two geo-positional locations.

13. The computing apparatus of claim 8, wherein the virtual geographic map is represented as a two dimensional map.

14. The computing apparatus of claim 8, wherein the virtual geographic map is represented as a three dimensional map.

15. A non-transitory computer-readable storage medium, the computer-readable storage medium including instructions that when executed by a computer, cause the computer to:
receive a data set comprising visual data, spatiotemporal data, geo-positional data, and point cloud data corresponding to at least one infrastructure asset and assigning the data set to a data pool through operation of an ingestion engine;
map the visual data, the spatiotemporal data, and the point cloud data for the at least one infrastructure asset to a geographic information system as at least one virtual asset through operation of a mapping engine configured by the geo-positional data for the at least one infrastructure asset;
visualize the at least one virtual asset with a placemark on virtual geographic map through an asset map user interface through operation of a data visualization engine;
display the visual data, the spatiotemporal data, the geo-positional data, and the point cloud data for the at least one virtual asset in response to selecting the placemark on the asset map user interface;
apply severity annotations to the at least one virtual asset through an annotations menu displayed on the asset inspector user interface;
group the at least one virtual asset with at least one other virtual asset based on proximity of the placemark on the virtual geographic map through operation of an image grouper;
generate an encroachment report comprising encroachment severity from the point cloud data of the at least one infrastructure assets in the data pool through operation of an encroachment analyzer;
generate an assets report comprising the severity annotations and the encroachment reports for the at least one infrastructure asset in the data pool through operation of a reporting tool.

16. The computer-readable storage medium of claim 15 further comprises an operations overlay display data pool statistics comprising the severity annotations and the encroachment severity of the at least one infrastructure assets in the data pool; and
displaying the asset inspector user interfaces, the encroachment analyzer, and the image grouper through the operations overlay.

17. The computer-readable storage medium of claim 15, wherein the encroachment analyzer is configured with measurements between points in a point cloud.

18. The computer-readable storage medium of claim 15, wherein the at least one virtual asset is associated with a plurality of visual data representing the at least one infrastructure asset from different angles.

19. The computer-readable storage medium of claim 15, wherein the data set represents a series of infrastructure assets between two geo-positional locations.

20. The computer-readable storage medium of claim 15, wherein the virtual geographic map is represented as a two dimensional map.

21. The computer-readable storage medium of claim 15, wherein the virtual geographic map is represented as a three dimensional map.
